(19) United States
(12) Patent Application Publication
(10) Pub. No.: US 2009/0308929 A1
(43) Pub. Date: Dec. 17, 2009

(54) Multifunctional Personalization System

(76) Inventor: Bertram Burkhardt, Cham (DE)

Correspondence Address: HOFFMAN WASSON & GITLER, P.C;CRYSTAL CENTER 2, SUITE 522, 2461 SOUTH CLARK STREET, ARLINGTON, VA, 22202-3843, US

(21) Appl. No.: 12/227,606

(22) PCT Filed: Apr. 14, 2007
(86) PCT No.: PCT/DE2007/000654

§ 371 Date: Nov. 17, 2008

(30) Foreign Application Priority Data
May 17, 2006 (DE) 10 2006 023 008.6

(51) Int. Cl. G06K 13/07

(52) U.S. Cl. 235/477; 235/375

(57) ABSTRACT

The invention relates to a multifunctional personalization system for personalization of identification or access elements, in particular of contactless and/or contact card elements, having at least two process modules designed for the execution of different personalization and/or control processes, at least one control unit, one card receiving unit, one card transport unit and one card output unit. The card transport unit is designed especially advantageously for single and/or multiple feeding of at least one identification or access element to single process modules, and the sequence of the feeding of the identification or access element to the individual process modules is independent of the arrangement of the process modules along the card transport unit.

### BACKGROUND OF THE INVENTION

The invention relates to a multifunctional personalization system for personalization of identification or access elements, in particular for personalization of contactless and/or contact card elements.

A prior-art portable personalization device for labeling data carrier elements, for example identification and access cards, by means of an integrated laser unit, in which labeling is implemented by means of the integrated laser unit—also underneath a plastic film covering the surface of the data carrier, is described in DE 20 2005 012 928 U1. The portable personalization device described above is therefore designed for labeling data carrier elements with different dimensions, for which purpose it features an exchangeable cartridge unit, which is designed for receiving and fastening a data carrier element of a specific form and type. For labeling different data carrier elements it is therefore necessary to insert the cartridge unit designed to receive the special data carrier elements into the portable personalization device. The portable personalization device has a modular design, i.e. it comprises a base frame module, into which an electronic module, a control module and a processing module designed in the form of a laser unit can be inserted.

Further, a prior modular processing system for processing personalization elements, in particular chip cards, smart cards or magnetic strip cards with a plurality of linearly arranged processing modules is described in DE 103 50 488 A1. The processing modules each comprise at least one first and second sub-module, the first sub-module being provided as a process module in a processing area above a common tabletop level of a system base frame and the second sub-module being provided as an electronic and process component module in a control and analysis area beneath the tabletop level. The modular processing system therefore comprises several different process modules for personalization of identification and access elements. The identification and access elements are fed to the process modules serially and in one transport direction. The disadvantage of this is that adaptation of the functional scope of the modular processing system, for example the inclusion of an additional personalization process between two already integrated processing modules, involves considerable modification. Also, the individual personalization processes can be carried out only in the specified sequence, namely consecutively, i.e. it is not possible to change the order of the personalization processes or to repeat the feeding of an identification and access element to a particular process module using the modular processing system described above.

Based on the existing art, the object of the present invention is to provide a multifunctional personalization system for personalizing identification or access elements that can be customized for a broad range of personalization requirements while enabling easy, centralized control.

### SUMMARY OF THE INVENTION

In an especially advantageous design, the card transport unit is designed for single and/or multiple feeding of at least one identification or access element to single process modules, the sequence of the feeding of the identification or access elements to the individual process modules being independent of the arrangement of the process modules along the card transport unit. By means of the card transport unit centrally arranged in the multifunctional personalization system it is possible to move to the various process modules in nearly any sequence and also repeatedly, i.e. the feeding of the identification or access elements can be adapted to individual personalization requirements.

Further, the sequence of the feeding to all or any selected process modules can be controlled individually. For this purpose the card transport unit for linear transport of the separate identification or access element is provided along a transport axis in a first transport direction and in a second transport direction that is opposed to the first transport direction.

Also advantageously the card transport unit comprises a turning device for turning the separate identification or access element. By providing a turning unit, both the back and the front of the card element can be personalized with different personalization processes independent of the arrangement and alignment of the process modules.

The process modules are arranged along the card transport unit and parallel to the transport axis in one processing plane, and the card transport unit comprises a transport belt with a transport slide element for receiving the identification or access element.

In an advantageous embodiment the card transport unit comprises at least one servo motor unit for driving the transport belt and the turning device, which for example enables clock pulsed feeding of the separated identification or access element to the process modules.

Especially advantageous is the fact that the multifunctional personalization system is integrated in a table housing module with an interior space, which is divided by the card transport unit into a first and second receiving space for receiving the process modules. The process modules can each be used parallel to the transport axis as modules in the first and second receiving space of the table housing module in practically any sequence and arrangement, which makes it possible to adapt the functional scope to retrofit the multifunctional personalization system for individual users, if necessary. Due to the integration of all units required for the execution and control of the different personalization and control processes in a table unit, the multifunctional personalization system is an individually configurable stand-alone system.

Especially advantageous is the provision of guide and/or fastening elements, which are compatible with connecting elements provided on the process modules, for fastening the process modules in the at least one receiving space

### BRIEF DESCRIPTION OF THE DRAWINGS

The invention is described in more detail based on selected exemplary embodiments with reference to the drawings, in which:

FIG. 1 is an exemplary perspective representation of the multifunctional personalization system;

FIG. 2 is an exemplary top view of the opened table housing module according to FIG. 1;

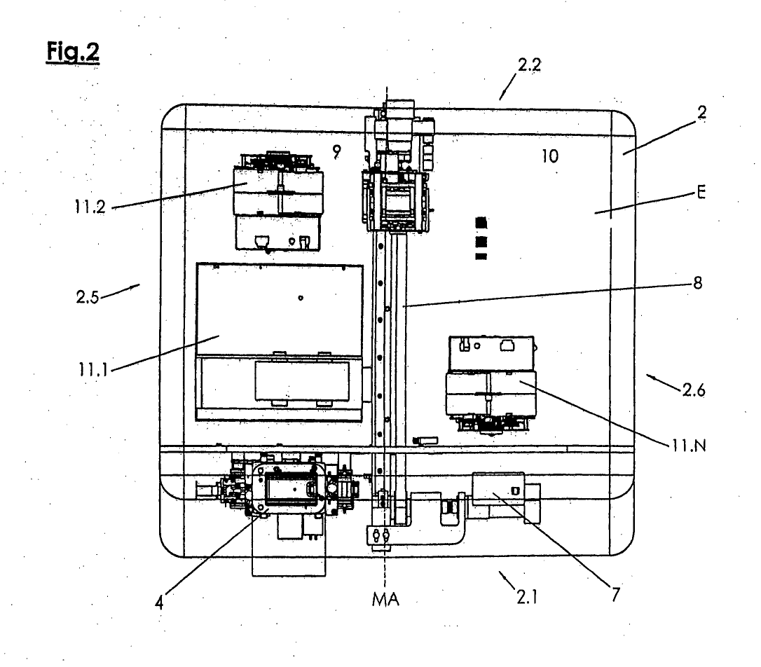

FIG. 3 is an exemplary side view of the closed table housing module;

FIG. 4 is a further exemplary perspective representation of the multifunctional personalization system according to FIG. 1;

FIG. 5 is an exemplary rear view of the closed table housing module, and

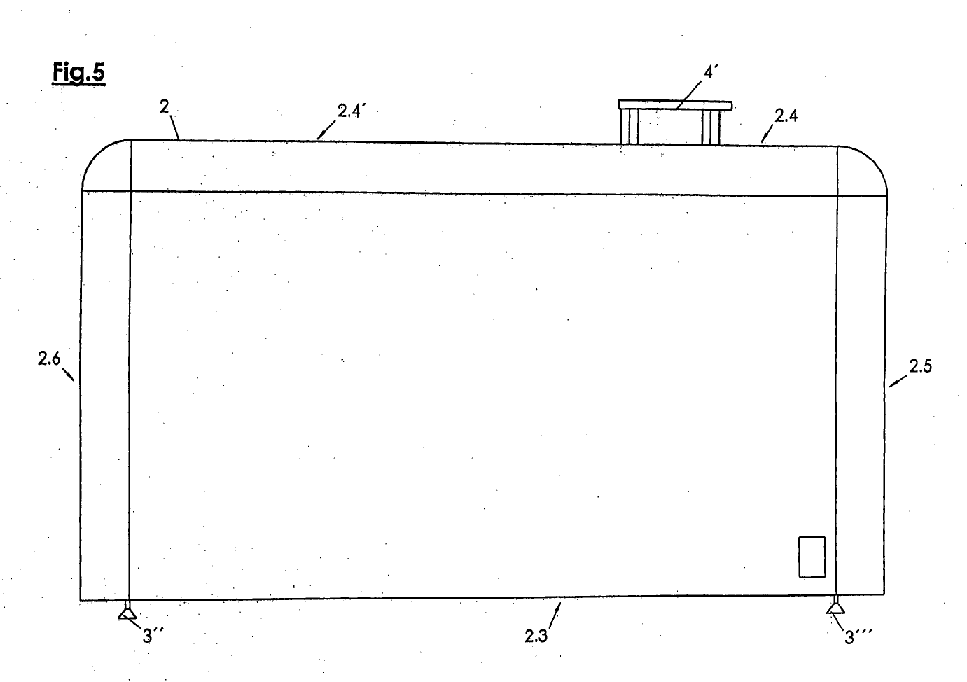

FIG. 6 is an exemplary perspective representation of the central card transport unit integrated in the table housing module.

### DETAILED DESCRIPTION OF THE INVENTION

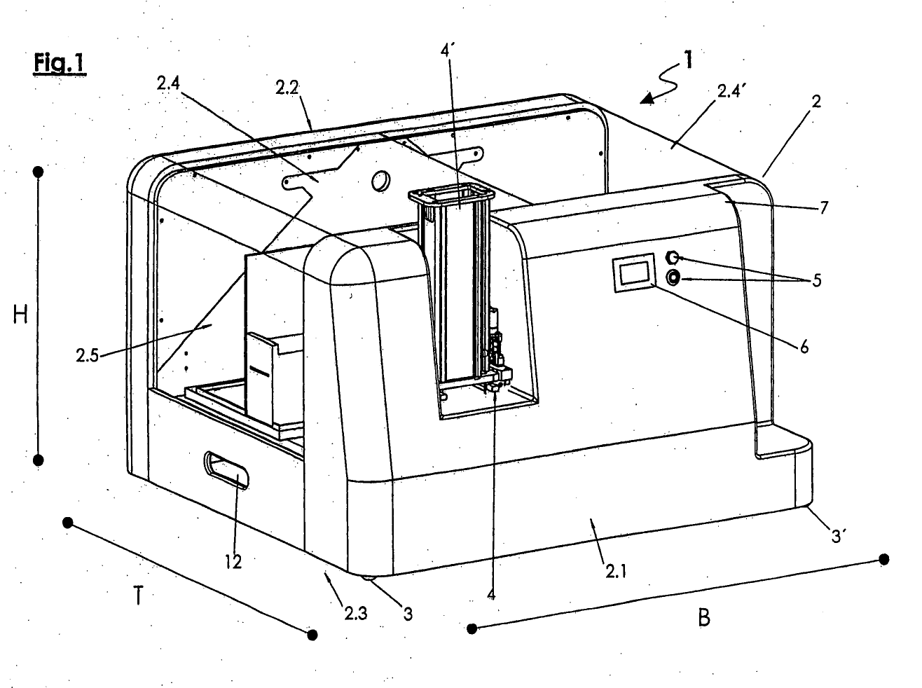

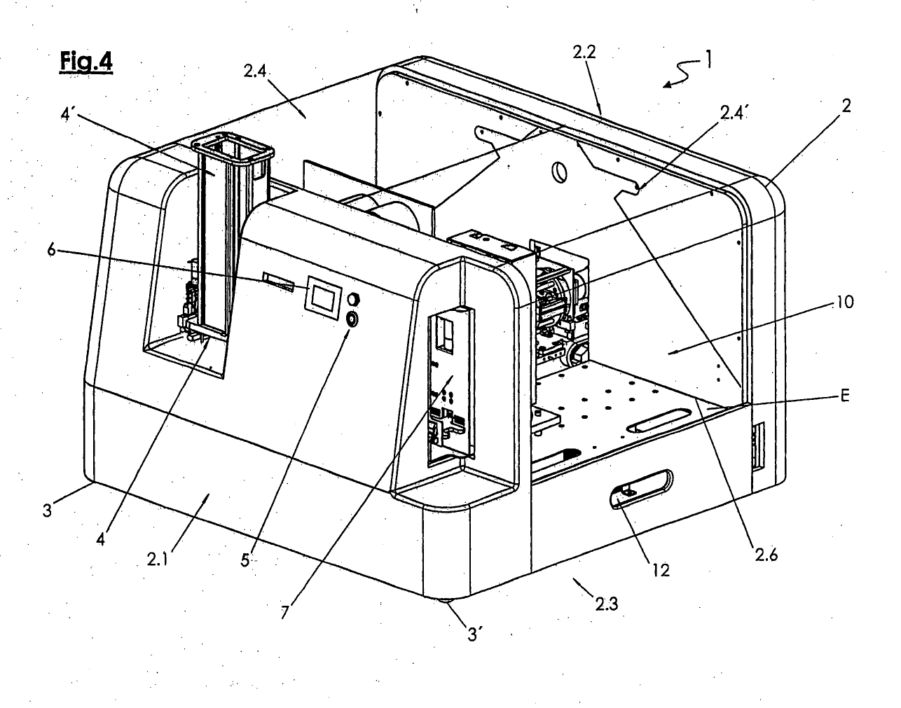

FIGS. 1 and 4 each show a perspective view of a multifunctional personalization system 1, which is integrated in a table housing module 2. The table housing module 2 comprises a housing front area 2.1 and a housing back area 2.2, which are connected with each other by at least one housing bottom area 2.3.

To form a closed table housing module 2 the housing front area 2.1 and the housing back area 2.2 are additionally connected with each other by at least one housing top element 2.4. In a preferred embodiment, the housing top element 2.4 has a two-part design, i.e. it comprises two separately controllable housing top elements 2.4, 2.4′.

Further, in a preferred embodiment the housing top elements 2.4, 2.4′ have an L-shaped cross section, so that they likewise close the two housing side areas 2.5, 2.6 of the table housing module 2. In closed state the table housing module 2 forms a cubical or rectangular parallelepiped housing.

In the area of the corners of the preferably rectangular housing bottom areas 2.3, downward protruding legs 3, 3′, 3″, 3′″ are provided, which preferably are arranged perpendicular to the housing bottom area 2.3. The legs 3, 3′, 3″, 3′″, are provided for positioning and alignment of the table housing module 2, which is located for example on a tabletop. The legs 3, 3′, 3″, 3′″ can be used for example to vary the distance from the housing bottom area 2.3 to the tabletop.

In the housing front area 2.1 of the table housing module 2, a card receiving unit 4 is provided for receiving the identification or access elements to be personalized, in particular for receiving contactless or contact card elements such as chip cards, smart cards and/or magnetic strip cards, and comprises for example a magazine or cartridge module 4′ for receiving a plurality of card elements. For separating the identification or access elements located in the magazine or cartridge module 4′, a card separating module is provided in the table housing module 2 or in the card receiving unit 4. The personalized identification or access elements are issued via a card output unit 7 provided in the housing front area 2.1. In a preferred embodiment the card output unit 7 comprises an output chute with a good/bad card sorting module.

Between the card receiving unit 4 and the card output unit 7, a card transport unit 8, which is preferably located centrally in the multifunctional personalization system, is provided for transport of the already separated identification or access elements or card elements along a transport axis TA. By means of the card transport unit 8 the separated identification or access elements or card elements can be transported along the transport axis TA in a first transport direction FR1 and in a second transport direction FR2 extending opposite to the first transport direction FR1, namely in a processing plane E. The first and second transport direction FR1, FR2 extend parallel to the transport axis TA.

The interior space 2′ of the table housing module 2 is divided by the card transport unit 8 into a first and second receiving space 9, 10, which extends for example between the housing front area 2.1 and the housing back area 2.2 and which, when the housing top element 2.4, 2.4′ is opened or removed, is freely accessible from the top and/or side. The first and second receiving spaces 9, 10 are provided in particular for receiving a first through Nth process module 11.1-11.N and are designed respectively for executing at least one personalization and/or control process, for example labeling of the card element or encoding of the chip element provided in the card element or magnetic strip element, etc. For example the first through Nth process modules 11.1-11.N can be implemented as magnetic strip encoding modules, thermal transfer printing modules, chip encoding modules, dye sublimation modules, laser modules, laminating modules, optical verification modules or as modules that comprise a combination of the above personalization and control functions. The first through Nth process modules 11.1-11.N are arranged parallel to the transport axis TA and likewise in the processing plane E.

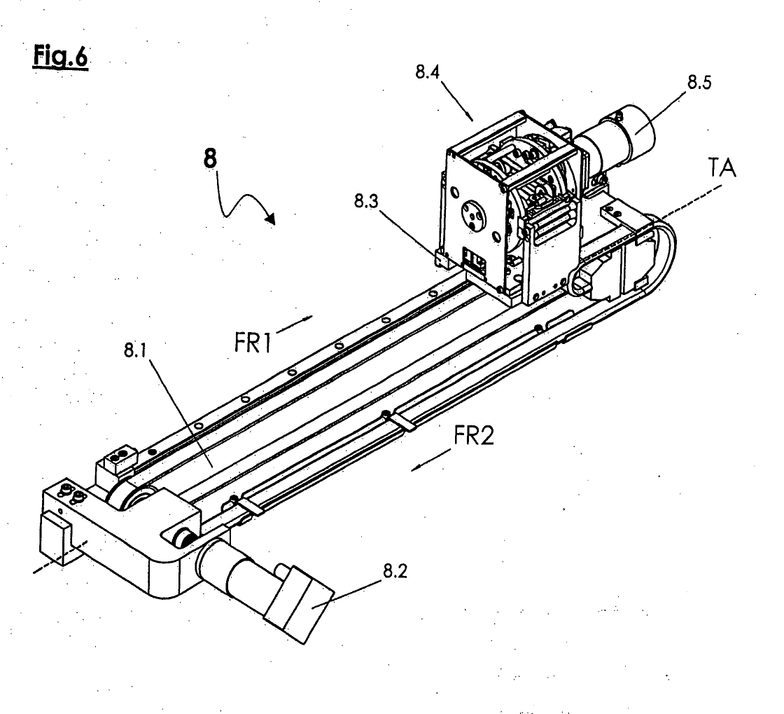

In a preferred embodiment according to FIG. 6, the card transport unit 8 comprises a transport belt 8.1, which is guided on two roller units located on the respective front ends of the transport card unit 8. To drive the transport belt 8.1 at least one of the roller units is connected with a servo motor unit 8.2, by means of which the transport belt 8.1 can be driven in the first and second transport direction FR1, FR2.

Further, the transport belt 8.1 is provided with a transport slide element 8.3, which is designed for receiving the separated identification or access element. A turning device 8.4 is mounted on the transport slide element 8.3 for turning the identification or access element, in order to enable the personalization and/or control of the front and back of the identification or access element in any sequence by the first through Nth process module 11.1-11.N. A further servo motor unit 8.5, for example, is provided for driving the turning device 8.4.

The card transport unit 8 therefore enables single and/or multiple feeding of the identification or access element to different process modules 11.1-11.N, and the sequence of the feeding of the identification or access element to the individual process modules 11.1-11.N is independent of the arrangement of the process modules 11.1-11.N along the card transport unit 8. Also, the card transport unit 8 can be designed for clock pulsed feeding of the separate identification or access element to the individual process modules 11.1-11.N.

Further, in a preferred embodiment, the first and second receiving space 9, 10 comprise special guide and/or fastening elements for fastening the process modules 11.1-11.N, which are arranged in the processing plane E and/or along the central card transport unit 8. For example, the guide and/or fastening elements can be designed as locking elements, into which the process modules 11.1-11.N can be inserted, respectively. For this purpose, the process modules 11.1-11.N comprise connecting elements, which are compatible with the guide and/or fastening elements located in the first and second receiving space 9, 10.

In the following, the function of the multifunctional personalization system 1 for an identification or access element designed as a card unit is described by way of example. The card element that is separately issued from the card receiving unit 4 is picked up by the central card transport unit 8, namely by the turning device 8.4 located on the transport slide element 8.3. Afterwards, the transport slide element 8.3 is transported in the first transport direction FR1 to a first process module 11.1. From the transport slide element 8.3 the card element is transferred to the first process module 11.1 and processed in a first personalization process. Then the at least partially personalized card element is transferred from the first process module 11.1 to the transport slide element 8.3 or the turning device 8.4 of the card transport unit 8 and again fed in the first transport direction FR1 to the second process module 11.2. The card element is likewise picked up by the second process module 11.2 and a second personalization process is executed. Analogous to this process, the personalization of the card element is continued until all individually specified personalization processes have been completed by the further process modules 11.3-11.N.

The process modules 11.1-11.N provided for personalization and/or control of the card element can be selected individually and the sequence of execution of the personalization and/or control process can be controlled in practically any sequence. Therefore, the process modules 11.1-11.N selected via the central card transport unit 8 can be fed with card elements for personalization more than once; for example after personalization of the back of the card element has been completed, the front of the card element can be processed by means of the same or a different process module 11.1-11.N. After completion of the personalization and/or control of the card element, said card element is fed via the central card transport unit 8 to the card output unit 7 and transferred to the latter. A good/bad card sorting module can be integrated in the table housing module 2 or in the card output unit 7 to sort out the card elements that are defective or do not conform to a specified quality standard.

Up to N personalization and/or control processes can be integrated as modules in the table housing module 2 in order to customize the functional scope or personalization scope of the personalization system 1. The personalization system 1 integrated in the table housing module 2 therefore embodies a multifunctional, modular personalization platform, which enables easy, independent and professional personalization of identification or access elements.

The multifunctional personalization system 1 can first be equipped in a basic extension stage for example with two process modules, 11.1, 11.2 and then be gradually expanded at a later time by the integration of additional process modules, up to the full extension stage. The table housing module 2, with N=7 different process modules 11.1-11.N, for example, has a width B of 700-900 mm, preferably 800 mm, a depth T of 700-900 mm, preferably 800 mm and a height H of 400-600 mm, preferably 500 mm.

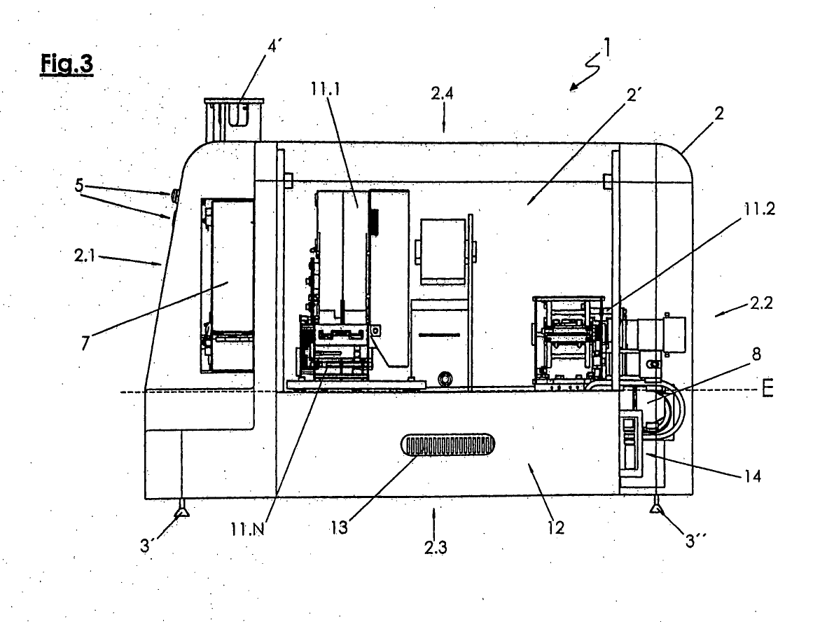

Further, according to FIG. 3, a control and analysis space 12 is provide in the housing bottom area 2.3 of the table housing module 2 and beneath the processing plane E, in which (space) at least one control unit 13, optionally with a storage unit, is located. The control unit 13 is designed for example as a personal computer unit and is provided for controlling the card transport unit 8 and therefore the card element handling. By means of a control routine likewise executed in the control unit 13, for example, all control signals required for controlling the process modules 11.1-11.N provided in the first and second receiving space 9, 10 are generated and transmitted to the respective process module 11.1-11.N via control lines and/or an internal bus system. Also, for controlling the correct execution of the different personalization processes, measured data can be transferred via control lines and/or the internal bus system to the control unit 13 and then analyzed for example by an analysis routine also executed in the control unit 13.

In a preferred embodiment, proprietary or standardized data transfer interfaces provided for connecting the individual process modules 11.1-11.N to the control unit 13 in the table housing module 2 are equipped with corresponding interface connections in the first and second receiving space 9 and 10. Examples of data transmission interfaces that can be provided are TCP/IP (“Transmission Control Protocol over Internet Protocol”) or SCSI (“Small Computer System Interface”).

For example, the control unit 13 can comprise different input and output units for the input and output of data, in addition to different connecting units 14. The manual configuration of the control unit 13 and/or the operation of the control and analysis routine executed in the control unit 13 can be controlled for example by means of a keyboard unit and/or an allocated monitor unit. The personalization data required for personalization of the identification and access elements are stored for example in the storage unit and transferred to the respective process module 11.1-11.7 via the control unit during the personalization process.

It is also possible to connect the multifunctional personalization system 1 via the connecting units 14 to a computer network. For this purpose, the multifunctional personalization system 1 is designed as a stand-alone system, which can be controlled by means of the connecting units 14 by a master computer unit that is remote from the personalization system 1.

Further, at least one operating module 5 and/or one display unit 6 is provided in the housing front area 2.1 for monitoring the control routine provided for the personalization process and/or for displaying the current status of the personalization process.

In a preferred embodiment, several different control and/or analysis routines can be provided and can be selected individually. For example, the number, type and/or sequence of the personalization steps can be specified by the respective control and/or analysis routine as needed.

The invention was described above based on an exemplary embodiment. It goes without saying that numerous variations and modifications are possible without abandoning the underlying inventive idea upon which the invention is based.

### REFERENCE LIST

1 multifunctional personalization system

2 table housing module

2′ interior

2.1 housing front area

2.2 housing back area

2.3 housing bottom area

2.4, 2.4′ housing top element(s)

2.5 housing side area

2.6 housing side area

3, 3′, 3″, 3′″ legs

4 card receiving unit

4′ magazine or cartridge module

5 operating module

6 display unit

7 card output unit

8 card transport unit

8.1 transport belt

8.2 servo motor unit

8.3 transport slide element

8.4 turning device

8.5 additional servo motor unit

9 first receiving space

10 second receiving space

11.1-11.N process modules

12 control and analysis space

13 control unit

14 connecting units

TA transport axis

E processing plane

FR1 first transport direction

FR2 second transport direction

What is claimed is:

1. A multifunctional personalization system for personalization of identification or access elements, comprising a plurality of process modules for execution of different personalization or control processes, at least one control unit, one card receiving unit, one card transport unit and one card output unit, wherein the card transport unit is for single or multiple feeding of at least one identification or access element to the plurality of single process modules, a sequence of the feeding of the identification or access elements to the individual process modules is independent of an arrangement of the process modules along the card transport unit (8) and that the sequence of the feeding to all or any selected process modules can be individually controlled.

2. The multifunctional personalization system according to claim 1, wherein the card transport unit for linear transport of the separate identification or access element is provided along a transport axis (TA) in a first transport direction (FR1) and in a second transport direction (FR2) that is opposed to the first transport direction (FR1).

3. The multifunctional personalization system according to claim 1, wherein the card transport unit comprises a turning device for turning the separate identification or access element.

4. The multifunctional personalization system according to claim 1, wherein the process modules are arranged along the card transport unit and parallel to the transport axis (TA) in a processing plane (E).

5. The multifunctional personalization system according to claim 1, wherein the card transport unit comprises a transport belt with a transport slide element.

6. The multifunctional personalization system according to claim 5, wherein the transport slide element receives the identification or access element.

7. The multifunctional personalization system according to claim 5, wherein the card transport unit comprises at least one servo motor unit to drive the transport belt and a turning unit.

8. The multifunctional personalization system according to claim 5, wherein the card transport unit feeds the separate identification or access element to the process modules.

9. The multifunctional personalization system according to claim 1, wherein the multifunctional personalization system is integrated in a table housing module with an interior space.

10. The multifunctional personalization system according to claim 9, wherein the interior space of the table housing module is divided by the card transport unit into a first and second receiving space for receiving the process modules.

11. The multifunctional personalization system according to claim 10, further comprising guide or fastening elements for fastening the process modules are provided in the at least first and second receiving space.

12. The multifunctional personalization system according to claim 11, wherein the process modules comprise compatible connecting elements for the guide or fastening elements.

13. The multifunctional personalization system according to claim 1, wherein the card receiving unit comprises a magazine or cartridge module for receiving a plurality of identification or access elements.

14. The multifunctional personalization system according to claim 9, wherein a card separating module is provided in the table housing module or in the card receiving unit.

15. The multifunctional personalization system according to claim 1, wherein the process modules are designed as magnetic strip encoding modules, thermal transfer printing modules, chip encoding modules, dye sublimation modules, laser modules, laminating modules, optical verification modules or as process modules that implement a combination of the above functions.

16. The multifunctional personalization system according to claim 9, wherein a good bad card sorting module is provided in the table housing module or in the card output unit.

17. A method for feeding at least one identification or access element, to a plurality of process modules provided in a multifunctional personalization system according to claim 1, wherein the at least one identification or access element is fed by means of a card transport unit provided centrally in the multifunctional personalization system to individual process modules independent of the arrangement of the process modules along the card transport unit singly or multiply, and the sequence of feeding to all or any selected process modules can be controlled individually.
